(19) United States
(12) Patent Application Publication
(10) Pub. No.: US 2017/0080493 A1
(43) Pub. Date: Mar. 23, 2017

(54) Methods For Evaluating The Properties Of Transient Liquid Phase Bonds

(71) Applicant: Toyota Motor Engineering & Manufacturing North America, Inc., Erlanger, KY (US)

(72) Inventors: Shailesh N. Joshi, Ann Arbor, MI (US); Masao Noguchi, Ann Arbor, MI (US)

(73) Assignee: Toyota Motor Engineering & Manufacturing North America, Inc., Erlanger, KY (US)

(21) Appl. No.: 14/862,629

(22) Filed: Sep. 23, 2015

(51) Int. Cl. B22F 3/10; C22C 13/00; G01N 27/04; G01N 9/36; G01N 3/02; G01N 25/00; B22F 3/105; G01N 19/04

(52) U.S. Cl. CPC B22F 3/1035; B22F 3/105; C22C 13/00; G01N 19/04; G01N 9/36; G01N 3/02; G01N 25/00; G01N 27/041; B22F 2003/1051; B22F 2201/20

(57) ABSTRACT

According to embodiments described herein, the properties of a transient liquid phase bond may be evaluated by a method that includes forming a bulk material sample. The bulk material sample may include the material of the transient liquid phase bond. Forming the bulk material sample may include providing a bonding material precursor and forming the bulk material sample by transient liquid phase bonding the bonding material precursor by spark plasma sintering the bonding material precursor. The bonding material precursor may include metal particles of a first metal composition and metal particles of a second metal composition. The method may further include testing the bulk material sample for one or more properties.

### TECHNICAL FIELD

The present specification generally relates to the bonding of substrates and, more specifically, to methods for measuring properties of bonding materials.

### BACKGROUND

Components of electrical devices which operate at elevated temperatures may need to be bonded with one another. For example, power semiconductor devices, such as those fabricated from silicon carbide, may be designed to operate at very high operating temperatures (e.g., greater than 250° C.). Such power semiconductor devices may be bonded to a cooling device, such as heat sink or a liquid cooling assembly. The cooling device removes heat from the power semiconductor to ensure that it operates at a temperature that is below its maximum operating temperature. The bonding layer that bonds the power semiconductor device to the cooling device must be able to withstand the high operating temperatures of the power semiconductor device. However, conventional bonding techniques, such as solder bonding, may be difficult and/or costly, and may not have sufficient bond strength over thermal cycling. Additionally, it may be difficult to measure mechanical properties of bonding layers which are utilized to bond two substrates with one another.

Accordingly, a need exists for alternative methods for measuring the properties of bonding layers that bond two substrates with one another.

### SUMMARY

In one embodiment, the properties of a transient liquid phase bond may be evaluated by a method comprising forming a bulk material sample. The bulk material sample may comprise the material of the transient liquid phase bond. Forming the bulk material sample may comprise providing a bonding material precursor and forming the bulk material sample by transient liquid phase bonding the bonding material precursor by spark plasma sintering the bonding material precursor. The bonding material precursor may comprise metal particles of a first metal composition and metal particles of a second metal composition.

In another embodiment, the properties of a transient liquid phase bond may be evaluated by a method comprising forming a bulk material sample and testing the bulk material sample for one or more properties. Forming the bulk material sample may comprise providing a bonding material precursor and forming the bulk material sample by transient liquid phase bonding the bonding material precursor by spark plasma sintering the bonding material precursor. The bonding material precursor may comprise metal particles of a first metal composition and metal particles of a second metal composition. The spark plasma sintering may comprise applying a pulsed direct current to the bonding layer precursor to heat the bonding layer precursor and applying pressure to the bonding layer precursor. The spark plasma sintering may take place in a vacuum environment. The properties that are tested may be chosen from elastic modulus, shear modulus, Poisson's ratio, elongation, ultimate stress, yielding stress, density, melting point, electric resistivity, coefficient of thermal expansion, creep, and thermal conductivity.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross-sectional side view of two substrates bonded to one another with a bonding layer, according to one or more embodiments shown and described herein;

FIG. 2 schematically depicts an enlarged cross-sectional side view of a portion of a bonding layer precursor positioned adjacent a the upper substrate prior to radiant heating by, according to one or more embodiments shown and described herein;

FIG. 3 schematically depicts an enlarged cross-sectional side view of a portion of a bonding layer positioned adjacent a substrate during radiant heating, according to one or more embodiments shown and described herein;

FIG. 4 schematically depicts an enlarged cross-sectional side view of a portion of a bonding layer following radiant heating, according to one or more embodiments shown and described herein;

FIG. 5 schematically depicts an example spark plasma sintering processing apparatus, according to one or more embodiments shown and described herein;

FIG. 6 schematically depicts an enlarged cross-sectional side view of a portion of a bulk sample material precursor during heating by spark plasma sintering, according to one or more embodiments shown and described herein;

FIG. 7 schematically depicts an enlarged cross-sectional side view of a portion of a bulk sample material during heating by spark plasma sintering, according to one or more embodiments shown and described herein; and

FIG. 8 schematically depicts an enlarged cross-sectional side view of a portion of a bulk sample material following heating by spark plasma sintering, according to one or more embodiments shown and described herein.

### DETAILED DESCRIPTION

Referring generally to the figures, embodiments of the present disclosure are directed to methods for evaluating the properties of transient liquid phase bonds by forming and testing a bulk sample material that has the same composition as that of bonding layer of a bonded system. In embodiments, two or more substrates may be bonded to one another with a thermally conductive bonding layer formed by transient liquid phase bonding. The transient liquid phase bonding layers disclosed herein may have relatively high melting points and may be thermally stable through exposure to heat that is of a higher temperature than that used to form the bonds. These bonds may be useful in applications where substrates experience thermal cycling at relatively high temperatures (e.g., greater than about 400° C.). For example, bonding techniques may not be suitable described herein may be suitable for systems exposed to the thermal cycling of a power semiconductor device.

Generally, in embodiments of transient liquid phase bonded substrates, each of the substrates may comprise a substrate bonding surface which contacts a bonding layer that is positioned between and contacting the substrates. The bonding layer may be formed from a bonding layer precursor that may comprise particles of one or more metals. The particles may undergo transient liquid phase bonding to form intermetallic alloy materials comprising the materials of the bonding layer precursor and the one or more substrates. In embodiments, the transient liquid phase bonding layers may be formed by conventional heating means, such as radiant or conductive heating.

The formed bonding layer is sandwiched between the two substrates in a layer that is relatively thin. Therefore, it may be difficult to measure various properties of the bonding layer. For example, the tensile properties of the material of the bonding layer such as the Young's modulus cannot be easily measured. Particularly, it may not be possible to measure some properties of the transient liquid phase bonding layer when the bonding layer is contained between the substrates. For example, some material testing requires a bulk material sample that is not attached to substrates. Therefore, in order to determine properties of the bonding layer, a bulk material sample may be prepared. For example, a rod of material may be prepared of the composition of the bonding layer to test the Young's modulus.

However, under conventional fabrication techniques, it is difficult or even impossible to form the material of the bonding layer without at least one of the substrates. For example, conventional heating apparatuses that utilize conductive or radiant heating may require that the bonding layer precursor material be applied with a binder to a substrate for stability.

It has been discovered that a bulk material sample of a transient liquid phase material that could be used as a bonding layer may be formed by utilizing a spark plasma sintering process. Generally, a spark plasma sintering process induces sintering by running a current through the bonding material precursor to heat the bonding material precursor. Spark plasma sintering may also include an application of pressure on the bonding material precursor. Once the bulk material sample is fabricated, it may be tested for various properties such as, without limitation, Young's modulus (i.e., elastic modulus), shear modulus, Poisson's ratio, elongation, ultimate stress, yielding stress, density, melting point, electric resistivity, coefficient of thermal expansion, creep, and thermal conductivity.

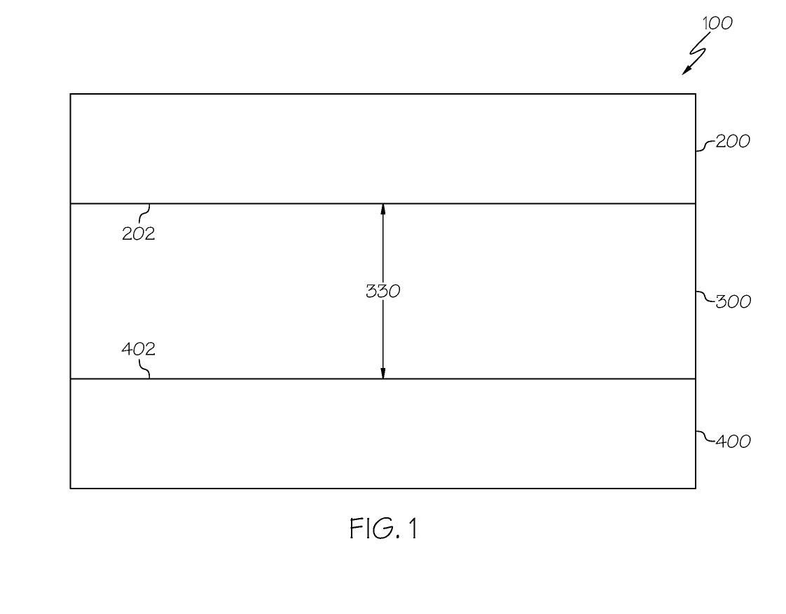

According to embodiments, a bulk material sample may be prepared which has an identical or substantially identical material to that of a bonding layer in a bonded system. FIG. 1 generally depicts a system of bonded substrates 100 comprising an upper substrate 200 and a lower substrate 400 bonded to one another with a bonding layer 300. The bonding layer 300 is positioned generally between the upper substrate 200 and the lower substrate 400 and directly contacting the upper substrate 200 at the upper substrate bonding surface 202 and the lower substrate 400 at the complementary lower substrate bonding surface 402. The bonding layer 300 may comprise alloys of metals, pure metals, or each in different portions of the bonding layer 300. As used herein, an “alloy” refers to a material composition that comprises at least two metallic or metalloid components, and a “pure metal” refers to a material that comprises at least about 99.5% of an elemental metal. As used herein “metals” refer to materials comprising metal elements, metalloid elements, or combinations thereof, in an amount of at least about 50%.

In one embodiment, the lower substrate bonding surface 402 and/or the upper substrate bonding surface 202 may be substantially planar and substantially parallel relative to one another. While one substrate is referred to herein as the “upper substrate” and the other substrate is referred to herein as the “lower substrate,” the two substrates 200, 400 need not necessarily be arranged above and below one another, and the nomenclature of “upper” and “lower” is merely representative of the relative positioning in the upper substrate 200 and lower substrate 400 as depicted in the drawings described herein. Additionally, it should be understood herein that any feature of the upper substrate 200 may be included in the lower substrate 400, and vice versa. Generally, the lower substrate 400 and the upper substrate 200 each comprise bonding surfaces, referred to as the lower substrate bonding surface 402 and upper substrate bonding surface 202, respectively. The lower substrate bonding surface 402 and upper substrate bonding surface 202 may be referred to as “complementary” herein, meaning that the two bonding surfaces generally have geometries making them suitable for bonding with one another, such as with a bonding layer 300 as described in embodiments herein.

It is contemplated herein that the composition of the lower substrate 400 at the lower substrate bonding surface 402 may be any of the material compositions disclosed herein as a composition of the lower substrate 400. Additionally, it is contemplated herein that the composition of the upper substrate 200 at the upper substrate bonding surface 202 may be any of the material compositions disclosed herein as a composition of the upper substrate 200. In some embodiments, the material composition of the lower substrate 400 and the upper substrate 200 may vary between the portions of each. For example, the material composition at the lower substrate bonding surface 402 may be different from the composition of other portions of the lower substrate 400, and the material composition at the upper substrate bonding surface 202 may be different from the composition of other portions of the upper substrate 200. For example, the upper substrate 200 or the lower substrate 400 may comprise a coating layer at the upper substrate bonding surface 202 or lower substrate bonding surface 402, respectively.

The lower substrate 400 may comprise a wide variety of materials, including, but not limited to, one or more metals or alloys such as, but not limited to, materials comprising copper, aluminum, nickel, or combinations thereof. In embodiments, the lower substrate 400 may comprise at least about 50% copper, at least about 60% copper, at least about 70% copper, at least about 80% copper, at least about 90% copper, at least about 95% copper, at least about 99% copper, at least about 99.5% copper, at least about 50% aluminum, at least about 60% aluminum, at least about 70% aluminum, at least about 80% aluminum, at least about 90% aluminum, at least about 95% aluminum, at least about 99% aluminum, at least about 99.5% aluminum, at least about 50% nickel, at least about 60% nickel, at least about 70% nickel, at least about 80% nickel, at least about 90% nickel, at least about 95% nickel, at least about 99% nickel, and/or at least about 99.5% nickel. For example, the lower substrate 400 may comprise a heat sink for a power electronic device.

In other embodiments, the lower substrate 400 may comprise metal oxides, metal nitrides, metal carbides, or combinations thereof, including, but not limited to, alumina, beryllium oxide, aluminum nitride, silicon carbide, or combinations thereof. For example, the lower substrate 400 may be a die for a power electronic device. In embodiments, the lower substrate 400 may comprise at least about 50% metal oxides, at least about 60% metal oxides, at least about 70% metal oxides, at least about 80% metal oxides, at least about 90% metal oxides, at least about 95% metal oxides, at least about 99% metal oxides, at least about 99.5% metal oxides, at least about 50% metal nitrides, at least about 60% metal nitrides, at least about 70% metal nitrides, at least about 80% metal nitrides, at least about 90% metal nitrides, at least about 95% metal nitrides, at least about 99% metal nitrides, at least about 99.5% metal nitrides, at least about 50% metal carbides, at least about 60% metal carbides, at least about 70% metal carbides, at least about 80% metal carbides, at least about 90% metal carbides, at least about 95% metal carbides, at least about 99% metal carbides, and/or at least about 99.5% metal carbides.

In one embodiment, the lower substrate 400 may comprise a direct bonded metal, such as, but not limited to, direct bonded copper (DBC) or direct bonded aluminum (DBA) at the lower substrate bonding surface 402. For example, direct bonded metallic layer may be bonded to a bulk material by a high-temperature oxidation process where copper and the bulk material are heated to a controlled temperature in an atmosphere of nitrogen containing about 30 ppm of oxygen to form a copper-oxygen eutectic. In another embodiment, the lower substrate 400 may comprise a material that is metal plated on the lower substrate bonding surface 402, such as a nickel plated lower substrate bonding surface 402.

The upper substrate 200 may comprise a wide variety of materials, including, but not limited to, one or more metals or alloys such as, but not limited to, materials comprising copper, aluminum, nickel, or combinations thereof. In embodiments, the upper substrate 200 may comprise at least about 50% copper, at least about 60% copper, at least about 70% copper, at least about 80% copper, at least about 90% copper, at least about 95% copper, at least about 99% copper, at least about 99.5% copper, at least about 50% aluminum, at least about 60% aluminum, at least about 70% aluminum, at least about 80% aluminum, at least about 90% aluminum, at least about 95% aluminum, at least about 99% aluminum, at least about 99.5% aluminum, at least about 50% nickel, at least about 60% nickel, at least about 70% nickel, at least about 80% nickel, at least about 90% nickel, at least about 95% nickel, at least about 99% nickel, and/or at least about 99.5% nickel. For example, the upper substrate 200 may comprise a heat sink for a power electronic device. It is contemplated herein that the composition of the upper substrate 200 at the upper substrate bonding surface 202 may be any of the material compositions disclosed herein.

In other embodiments, the upper substrate 200 may comprise metal oxides, metal nitrides, metal carbides, or combinations thereof, including, but not limited to, alumina, beryllium oxide, aluminum nitride, silicon carbide, or combinations thereof. For example, the upper substrate 200 may comprise a die for a power electronic device. In embodiments, the upper substrate 200 may comprise at least about 50% metal oxides, at least about 60% metal oxides, at least about 70% metal oxides, at least about 80% metal oxides, at least about 90% metal oxides, at least about 95% metal oxides, at least about 99% metal oxides, at least about 99.5% metal oxides, at least about 50% metal nitrides, at least about 60% metal nitrides, at least about 70% metal nitrides, at least about 80% metal nitrides, at least about 90% metal nitrides, at least about 95% metal nitrides, at least about 99% metal nitrides, at least about 99.5% metal nitrides, at least about 50% metal carbides, at least about 60% metal carbides, at least about 70% metal carbides, at least about 80% metal carbides, at least about 90% metal carbides, at least about 95% metal carbides, at least about 99% metal carbides, and/or at least about 99.5% metal carbides. It is contemplated herein that the composition of the upper substrate 200 at the upper substrate bonding surface 202 may be any of the material compositions disclosed herein.

In one embodiment, the upper substrate 200 may comprise a direct bonded metal, such as, but not limited to, direct bonded copper (DBC) or direct bonded aluminum (DBA) at the upper substrate bonding surface 202. For example, direct bonded metallic layer may be bonded to a bulk material by a high-temperature oxidation process where copper and the bulk material are heated to a controlled temperature in an atmosphere of nitrogen containing about 30 ppm of oxygen to form a copper-oxygen eutectic. In another embodiment, the upper substrate 200 may comprise a material that is metal plated on the upper substrate bonding surface 202, such as a nickel plated upper substrate bonding surface 202.

The bonding layer 300 may comprise a transient liquid phase bonded material. In embodiments, the transient liquid phase bonded material may undergo transient liquid phase bonding by a heating process, such as radiant heating under pressure. Generally, transient liquid phase bonding is characterized by a bond between two or more materials that may be stable to heating conditions above those in which the bond is formed. To form a transient liquid phase bond, a low melting point material and a high melting point material are utilized to form an intermetallic alloy comprising the materials of the high melting point material and the low melting point material. The high melting point material and the low melting point material may be referred to as precursor materials, and following the transient liquid phase bonding process (e.g., by radiant heating or other means) the precursor materials are at least partially converted to an intermetallic alloy. As used herein, a low melting point material refers to a material in a transient liquid phase bonding process which has a lower melting point than the high melting point material. The transient liquid phase bonding process may utilize a heating temperature that is between the melting points of the low melting point material and the high melting point material.

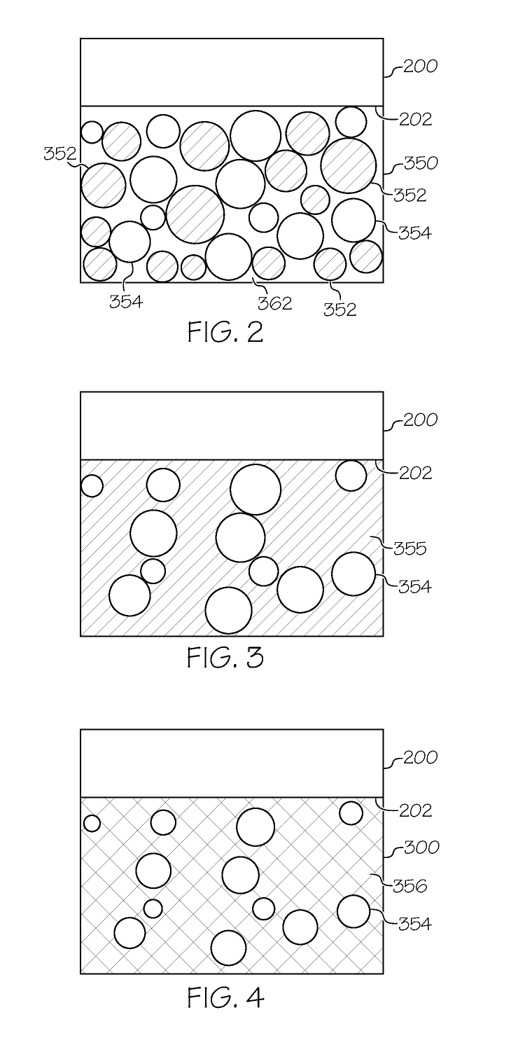

The formation of the transient liquid phase bond of the bonding layer 300 will be described in additional detail with reference to FIGS. 2-4. FIG. 2 schematically depicts an enlarged cross-section side view of a bonding layer precursor 350 adjacent a substrate prior to heating, where the enlarged view depicts only the interface of the upper substrate 200 with the bonding layer precursor 350 (and does not show the lower substrate 400). The bonding layer precursor 350 may comprise a plurality of particles, which are contained in an organic binder 362. The particles may have an average particle size of, without limitation, from about 1 micron to about 200 microns, such as from about 2 microns to about 50 microns. The bonding layer precursor 350 may comprise two or more material compositions. For example, FIG. 3 depicts particles having two different material compositions. Particles 352 may comprise a low melting point material and particles 354 may comprise a high melting point material. In some embodiments, the high melting point material may be identical to that of the substrate 200. The bonding layer precursor 350 may be packed by the applied pressure supplied by the spark plasma sintering apparatus.

In one embodiments, the low melting point particles 352 may comprise a wide variety of materials, including, but not limited to, one or more metals or alloys such as, but not limited to, materials comprising tin, such as at least about 50% tin, at least about 60%, at least about 70% tin, at least about 80% tin, at least about 90% tin, at least about 95% tin, at least about 99% tin, or even at least about 95.5% tin. In embodiments, the low melting point material may have a melting point of less than about 600° C., less than about 550° C., less than about 500° C., less than about 450° C., less than about 400° C., less than about 350° C., less than about 300° C., or even less than about 250° C. For example, tin has a melting point of about 232° C.

The high melting point particles 354 may comprise a wide variety of materials, including, but not limited to, one or more metals or alloys such as, but not limited to, materials comprising copper, aluminum, nickel, or combinations thereof. In embodiments, the upper substrate 200 may comprise at least about 50% copper, at least about 60% copper, at least about 70% copper, at least about 80% copper, at least about 90% copper, at least about 95% copper, at least about 99% copper, at least about 99.5% copper, at least about 50% aluminum, at least about 60% aluminum, at least about 70% aluminum, at least about 80% aluminum, at least about 90% aluminum, at least about 95% aluminum, at least about 99% aluminum, at least about 99.5% aluminum, at least about 50% nickel, at least about 60% nickel, at least about 70% nickel, at least about 80% nickel, at least about 90% nickel, at least about 95% nickel, at least about 99% nickel, and/or at least about 99.5% nickel.

In other embodiments, the high melting point particles 354 may comprise metal oxides, metal nitrides, metal carbides, or combinations thereof, including, but not limited to, alumina, beryllium oxide, aluminum nitride, silicon carbide, or combinations thereof. In embodiments, the high melting point particles 354 may comprise at least about 50% metal oxides, at least about 60% metal oxides, at least about 70% metal oxides, at least about 80% metal oxides, at least about 90% metal oxides, at least about 95% metal oxides, at least about 99% metal oxides, at least about 99.5% metal oxides, at least about 50% metal nitrides, at least about 60% metal nitrides, at least about 70% metal nitrides, at least about 80% metal nitrides, at least about 90% metal nitrides, at least about 95% metal nitrides, at least about 99% metal nitrides, at least about 99.5% metal nitrides, at least about 50% metal carbides, at least about 60% metal carbides, at least about 70% metal carbides, at least about 80% metal carbides, at least about 90% metal carbides, at least about 95% metal carbides, at least about 99% metal carbides, and/or at least about 99.5% metal carbides.

In embodiments, the high melting point particles 354 may have melting points of at least about 300° C., at least about 400° C., at least about 500° C., at least about 600° C., at least about 800° C., or even at least about 1000° C.

For example, in embodiments the material of the high melting point particles 354 may have a melting point of at least about 50° C. greater, at least about 100° C. greater, at least about 200° C. greater, or even at least about 400° C. greater than the material of the low melting point particles 352.

As described above, the system is heated, such as by oven, to heat the low melting point particles 352. FIG. 3 depicts the bonding layer while the transient liquid phase bonding is taking place. As the bonding layer precursor 350 is heated, the low melting point particles 352 melt to form a low melting point material matrix 355. The heating also burns off the organic binder 362 At this stage, the low melting point particles 352 have melted to surround and directly contact the high melting point particles 354. Additionally, at this temperature, some of the material of the low melting point particles 352, now melted as the low melting point material matrix 355, diffuses into the high melting point particles 354. The diffusion of the material of the low melting point material matrix 355 into the high melting point particles creates an intermetallic alloy comprising the materials of the low melting point particles 352 and the high melting point particles 354. However, the alloy formed by diffusion has a higher melting point, and due to the liquidus and solidus concentrations at a given temperature above the melting point of the low melting point material, solid intermetallic is formed even at temperatures above that of the melting point of the low melting point material. The same phenomena of diffusion may also occur at the interface of the substrate 200, where an intermetallic alloy is formed from diffusion of the low melting point material into the substrate 200. The material of low melting point continues to diffuse into the material of high melting point to form intermetallic alloys that at least partially solidify at the heating temperature.

FIG. 4 depicts a bonding layer that has been formed by transient liquid phase bonding. The bonding layer 300 comprises some particles 354 of high melting point material in an intermetallic alloy 356 comprising the materials of the high melting point particles 354 and the low melting point particles 352. High melting point particles 354 are reduced in size because some of its material is present in the intermetallic alloy 356.) Following the heating, the system is cooled to fully solidify the bonding layer 300.

For example, in a system with a tin material for the low melting point particles 352 and copper fort the high melting point particles 354 and substrate, the tin may have a melting point of about 232° C. and the copper may have a melting point of about 1085° C. In such an embodiment, a bonding temperature of greater than about 250° C. but less than about 1000° C. may be utilized. The transient liquid phase bonding may form an alloy comprising tin and copper as the intermetallic alloy 356.

Referring again to FIG. 1, the resulting bonded substrates 200, 400 may be spaced by a thickness 330 of the bonding layer 300, which is the distance between the upper substrate bonding surface 202 and the lower substrate bonding surface 402. In embodiments, the thickness 330 of the bonding layer 300 may be from about 5 microns to about 5000 microns, from about 50 microns to about 1000 microns, or from about 100 microns to about 500 microns. For example, the thickness 330 of the bonding layer 300 may be at least about 5 microns, at least about 25 microns, at least about 50 microns, at least about 100 microns, at least about 200 microns, at least about 500 microns, less than or equal to about 10000 microns, less than or equal to about 5000 microns, less than or equal to about 1000 microns, less than or equal to about 500 microns, less than or equal to about 250 microns, less than or equal to about 100 microns, or combinations thereof.

In order to measure the properties of the material of the bonding layer 300, a bulk material sample may be formed. However, to form the bulk material sample, the material of the bonding layer need be separate from the substrates and be sufficient in size to allow for various testing. It has been discovered that a bulk material sample, having the same or substantially the same material composition of a transient liquid phase bonding layer, may be produced by spark plasma sintering. The bulk material sample may be a transient liquid phase material comprising substantially the same composition as a bonding layer.

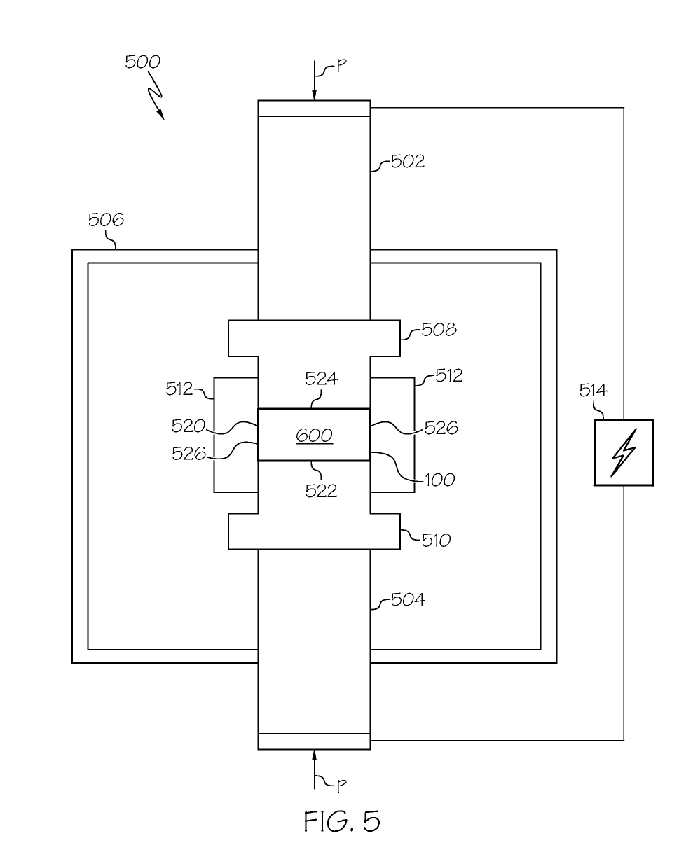

FIG. 5 schematically depicts an example of a spark plasma sintering processing apparatus 500. The spark plasma sintering processing apparatus 500 may comprise an upper electrode 502, a lower electrode 504, a vacuum chamber 506, a DC pulse generator 514, and a chamber die 512. The upper electrode 502 may comprise an upper punch 508, and the lower electrode 504 may comprise a lower punch 510. The chamber die 512 and the upper and lower punches 508, 510 may define a sintering chamber 520, where the lower punch 510 defines a floor 522 of the sintering chamber 520, the chamber die defines the sides 526 of the sintering chamber 520, and the upper punch 503 defines the ceiling 524 of the sintering chamber 520.

Generally, the sample to be sintered is placed in the sintering chamber 520 during processing. FIG. 5 depicts a bulk material sample 600 in the sintering chamber 520, where the lower substrate 400 is adjacent the lower punch 510, the upper substrate 200 is adjacent the upper punch 508, and the bonding layer 300 is positioned between the lower substrate 400 and the upper substrate 200. During spark plasma sintering processing, pressure (labeled with arrows marked “P” in FIG. 2) is applied by the lower electrode 504 and the upper electrode 502 such that the materials housed in the sintering chamber 520 come under lateral pressure by the upper and lower punches 508, 510. Additionally, during the spark plasma sintering processing, a DC pulse is applied to the material housed in the sintering chamber 520 by the DC pulse generator 514. The DC pulse generator 514 sends an electrical pulse through the upper electrode 502, through the chamber die 512, and into the lower electrode 504. The resistance of the materials housed in the sintering chamber 520 heats the sintering chamber 520 when electrical pulsing is applied by the DC pulse generator 514. The sintering temperatures may be controlled by variations is several parameters of the DC pulse including, but not limited to, electrical pulse holding time, pulsing ramp rate, pulse duration, and pulse current and voltage. Without being bound by theory, the DC pulse discharge may generate spark plasma, spark impact pressure, Joule heating, and/or an electrical field diffusion effect.

In embodiments, the spark plasma sintering processing may comprise a chamber evacuation step, application of pressure, application of an electrical current, and cooling. In the chamber evacuation step, the vacuum chamber 506 may be evacuated of air to form a vacuum condition. As used herein, a vacuum condition does not refer to a theoretic vacuum (P=0), but rather a low pressure common in laboratory vacuum conditions such as less than about 5%, less than about 1%, or even less than about 0.1% of atmospheric pressure. In the application of pressure step, the upper punch 508 and lower punch 510 apply pressure upon the contents of the sintering chamber 520. Applied pressure may be in a range from about 1 MPa to about 50 MPa, such as, for example, from about 5 MPa to about 40 MPa, or from about 20 MPa to about 30 MPa. The voltage and current of the electrical pulsing may vary, and may depend upon the materials to be sintered. Heating may be to a temperature between the melting points of the high melting point material and the low melting point material in order to form the transient liquid phase bulk material sample.

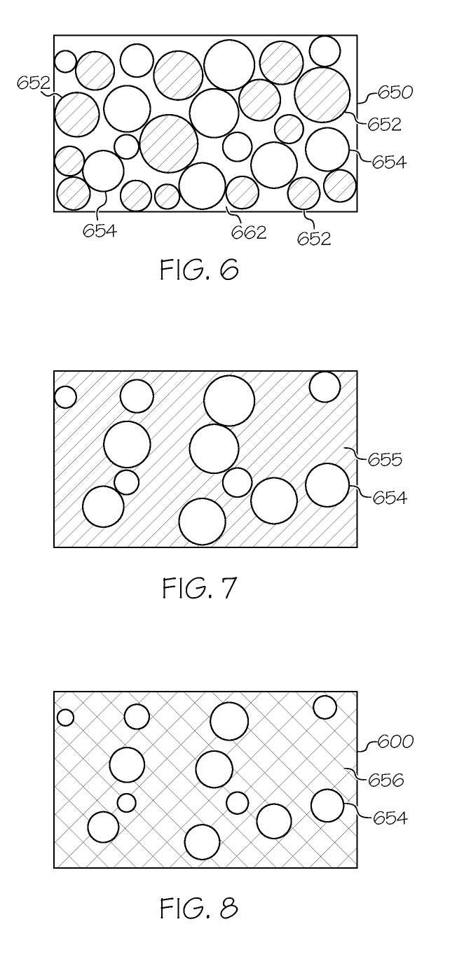

A transient liquid phase bulk sample material 600 may be fabricated by spark plasma sintering to form a material that is substantially similar or identical to that of the bonding layer 300. The formation of the bulk sample material 600 will be described in additional detail with reference to FIGS. 6-8. FIG. 6 schematically depicts an enlarged cross-section view of a bulk material sample precursor 650. The bulk sample material precursor 650 may comprise a plurality of particles, such as in a powder phase. The particles may have an average particle size of from about 1 micron to about 200 microns, such as from about 2 microns to about 50 microns. For spark plasma sintering an organic binder may not be incorporated in the bulk sample material precursor 650. The bulk sample material precursor 650 may comprise two or more material compositions. For example, FIG. 6 depicts particles having two different material compositions. Particles 352 may comprise a low melting point material and particles 354 may comprise a high melting point material. In some embodiments, the high melting point material may be identical to that of the substrate 200. The bulk sample material precursor 650 may be packed by the applied pressure supplied by the spark plasma sintering apparatus.

The low melting point material and high melting point material of the bulk sample material precursor 650 may be the same as those used in the bonding layer precursor 350. For example, in embodiments, the low melting point particles 652 may comprise a wide variety of materials, including, but not limited to, one or more metals or alloys such as, but not limited to, materials comprising tin, such as at least about 50% tin, at least about 60%, at least about 70% tin, at least about 80% tin, at least about 90% tin, at least about 95% tin, at least about 99% tin, or even at least about 95.5%. In embodiments, the low melting point material may have a melting point of less than about 600° C., less than about 550° C., less than about 500° C., less than about 450° C., less than about 400° C., less than about 350° C., less than about 300° C., or even less than about 250° C. For example, tin has a melting point of about 232° C.

The high melting point particles 654 may comprise a wide variety of materials, including, but not limited to, one or more metals or alloys such as, but not limited to, materials comprising copper, aluminum, nickel, or combinations thereof. In embodiments, the upper substrate 200 may comprise at least about 50% copper, at least about 60% copper, at least about 70% copper, at least about 80% copper, at least about 90% copper, at least about 95% copper, at least about 99% copper, at least about 99.5% copper, at least about 50% aluminum, at least about 60% aluminum, at least about 70% aluminum, at least about 80% aluminum, at least about 90% aluminum, at least about 95% aluminum, at least about 99% aluminum, at least about 99.5% aluminum, at least about 50% nickel, at least about 60% nickel, at least about 70% nickel, at least about 80% nickel, at least about 90% nickel, at least about 95% nickel, at least about 99% nickel, and/or at least about 99.5% nickel. In other embodiments, the high melting point particles 654 may comprise metal oxides, metal nitrides, metal carbides, or combinations thereof, including, but not limited to, alumina, beryllium oxide, aluminum nitride, silicon carbide, or combinations thereof. For example, the upper substrate 200 may comprise a die for a power electronic device. In embodiments, the upper substrate 200 may comprise at least about 50% metal oxides, at least about 60% metal oxides, at least about 70% metal oxides, at least about 80% metal oxides, at least about 90% metal oxides, at least about 95% metal oxides, at least about 99% metal oxides, at least about 99.5% metal oxides, at least about 50% metal nitrides, at least about 60% metal nitrides, at least about 70% metal nitrides, at least about 80% metal nitrides, at least about 90% metal nitrides, at least about 95% metal nitrides, at least about 99% metal nitrides, at least about 99.5% metal nitrides, at least about 50% metal carbides, at least about 60% metal carbides, at least about 70% metal carbides, at least about 80% metal carbides, at least about 90% metal carbides, at least about 95% metal carbides, at least about 99% metal carbides, and/or at least about 99.5% metal carbides.

In embodiments, the high melting point particles 654 may have melting points of at least about 300° C., at least about 400° C., at least about 500° C., at least about 600° C., at least about 800° C., or even at least about 1000° C. For example, in embodiments the material of the high melting point particles 654 may have a melting point of at least about 50° C. greater, at least about 100° C. greater, at least about 200° C. greater, or even at least about 400° C. greater than the material of the low melting point particles 652.

As described above, a direct electric pulsed current is applied through the bulk sample material precursor 650 to heat the low melting point particles 352. FIG. 7 depicts the bulk sample material 600 while the transient liquid phase bonding is taking place. As the direct current passes through the bulk sample material precursor 650, the low melting point particles 652 melt to form a low melting point material matrix 655. At this stage, the low melting point particles 652 have melted to surround and directly contact the high melting point particles 654. Additionally, at this temperature, some of the material of the low melting point particles 652, now melted as the low melting point material matrix 655, diffuses into the high melting point particles 654. The diffusion of the material of the low melting point material matrix 655 into the high melting point particles creates an intermetallic alloy comprising the materials of the low melting point particles 652 and the high melting point particles 654. However, the alloy formed by diffusion has a higher melting point, and due to the liquidus and solidus concentrations at a given temperature above the melting point of the low melting point material, solid intermetallic is formed even at temperatures above that of the melting point of the low melting point material. The material of low melting point continues to diffuse into the material of high melting point to form intermetallic alloys that at least partially solidify at the heating temperature.

FIG. 8 depicts a bulk sample material 600 that has been formed by transient liquid phase bonding. The bulk sample material 600 comprises some particles 654 of high melting point material in an intermetallic alloy 656 comprising the materials of the high melting point particles 654 and the low melting point particles 652. High melting point particles 654 are reduced in size because some of its material is present in the intermetallic alloy 656.) Following the heating by the direct current, the current is stopped and cooling takes place to fully solidify the bonding layer 600.

For example, in a system with a tin material for the low melting point particles 652 and copper for the high melting point particles 654 and substrate, the tin may have a melting point of about 232° C. and the copper may have a melting point of about 1085° C. In such an embodiment, the spark plasma sintering process may be utilize a bonding temperature of greater than about 250° C. but less than about 1000° C. The transient liquid phase bonding may form an alloy comprising tin and copper as the intermetallic alloy 656 as the bulk sample material 600.

In embodiments, the utilization of spark plasma sintering may form a bulk sample material 600 that is sufficiently voidless and does not require the use of flux. Therefore, an advantage of the presently disclosed process of forming a bulk sample material 600 by spark plasma sintering is that flux is not needed, and voids can be reduced or eliminated without the use of flux. In embodiments, the bonding layers described herein may be substantially voidless. For example, the bulk sample material may have void areas (i.e., areas comprising gases) of less than about 2%, less than about 1%, less than about 0.5%, or even less than about 0.1% of the total volume of the bulk sample material.

Following the formation of the bulk sample material 600, the bulk sample material 600 may be shaped or formed as needed for various property testing. For example, the the bulk material sample 600 may be tested for one or more of elastic modulus, shear modulus, Poisson's ratio, elongation, ultimate stress, yielding stress, density, melting point, electric resistivity, coefficient of thermal expansion, and thermal conductivity. For various tensile testing processes, the bulk sample material 600 may be formed to an appropriate geometry, such as a dog-bone shape, a cylindrical rod, or a rectangular rod.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

As used throughout this disclosure, percentages of components in a material composition are described by their weight percent. For example, “%” as used herein refers to the weight percent of a component.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for evaluating the properties of a transient liquid phase bond, the method comprising:
forming a bulk material sample comprising the material of the transient liquid phase bond, wherein forming the bulk material sample comprises:
providing a bonding material precursor comprising metal particles of a first metal composition and metal particles of a second metal composition; and
forming the bulk material sample by transient liquid phase bonding the bonding material precursor by spark plasma sintering the bonding material precursor.

2. The method of claim 1, wherein the spark plasma sintering comprises applying a direct current to the bonding material precursor.

3. The method of claim 2, wherein the application of the direct current heats the bonding material precursor.

4. The method of claim 2, wherein the direct current is pulsed.

5. The method of claim 1, wherein the spark plasma sintering comprises applying pressure to the bonding material precursor.

6. The method of claim 1, wherein the spark plasma sintering takes place in a vacuum environment.

7. The method of claim 1, further comprising testing the bulk material sample for one or more properties.

8. The method of claim 7, wherein the bulk material sample is tested for one or more of elastic modulus, shear modulus, Poisson's ratio, elongation, ultimate stress, yielding stress, density, melting point, electric resistivity, coefficient of thermal expansion, creep, and thermal conductivity.

9. The method of claim 1, wherein the first metal composition has a melting point of less than about 400° C.

10. The method of claim 1, wherein the second metal composition has a melting point of greater than about 500° C.

11. The method of claim 1, wherein the melting point of the first metal composition is at least about 100° C. less than the melting point of the second metal composition.

12. The method of claim 1, wherein the first metal composition comprises at least about 95% tin.

13. The method of claim 1, wherein the second metal composition comprises at least about 95% of aluminum, nickel, copper, or combinations thereof.

14. The method of claim 1, wherein the bulk material sample comprises an alloy of tin.

15. The method of claim 1, wherein the bulk material sample comprises an alloy of tin, and further comprises aluminum, nickel, copper, or combinations thereof.

16. The method of claim 1, further comprising shaping the bulk material sample prior to testing the bulk material sample for one or more properties.

17. The method of claim 1, wherein the bonding layer is substantially voidless.

18. The method of claim 1, wherein forming a bulk material sample does not utilize a flux.

19. A method for evaluating the properties of a transient liquid phase bond, the method comprising:
forming a bulk material sample comprising the material of the transient liquid phase bond, wherein forming the bulk material sample comprises:
providing a bonding material precursor comprising metal particles of a first metal composition and metal particles of a second metal composition; and
forming the bulk material sample by transient liquid phase bonding the bonding material precursor by spark plasma sintering the bonding material precursor, the spark plasma sintering comprising:
applying a pulsed direct current to the bonding layer precursor to heat the bonding layer precursor; and
applying pressure to the bonding layer precursor, wherein the spark plasma sintering takes place in a vacuum environment; and
testing the bulk material sample for one or more properties chosen from elastic modulus, shear modulus, Poisson's ratio, elongation, ultimate stress, yielding stress, density, melting point, electric resistivity, coefficient of thermal expansion, creep, and thermal conductivity.

20. The method of claim 19, wherein the bulk material sample comprises an alloy of tin.
